(19) United States
(12) Patent Application Publication
(10) Pub. No.: US 2008/0162502 A1
(43) Pub. Date: Jul. 3, 2008

(54) SYSTEM INTEGRATED FLEXIBLE DEVELOPMENT PROCESS

(76) Inventors: Udo KLEIN, Maximiliansau (DE); Thomas WIECZOREK, Meckesheim (DE); Daniel ZIMMERMANN, Leimen (DE); Oliver SIEVI, Sandhausen (DE); Guenter PECHT-SEIBERT, Muehlhausen (DE)

Correspondence Address: KENYON & KENYON LLP, 1500 K STREET N.W., WASHINGTON, DC, 20005, US

(21) Appl. No.: 11/616,445

(22) Filed: Dec. 27, 2006

(51) Int. Cl. G06F 7/00

(52) U.S. Cl. 707/100

(57) ABSTRACT

Flexible systems and methods are described that permit a development object to be tracked and moved through a development life cycle without the need to change hard-coded rules embedded in the development objects and tools themselves. An abstraction layer may be created that includes a status-action schema. The status-action schema may include action rules. Given the development status of a development object, an appropriate rule may be selected. The action rule may be applied to the development object to move the object to the next stage of the development life cycle. This may occur for more than one development objects and their associated development status(es). A configuration interface may be provided to aid in creating and updating the status-action schema.

### BACKGROUND

The software development life cycle often includes dependencies that must be satisfied from stage to stage. For example, before a software patch may be released to a customer, it must be thoroughly tested and a software development manager must sign off on it. Tracking software code, documentation, data, and other objects through these dependencies presents a challenge for software development organizations. Typically, tracking systems hard-code the actions that should be taken on a development object at various stages of the development process. These systems are thus inflexible, expensive to construct, and expensive to maintain.

Rules that define what actions must be taken on a development object at a given stage are often hardcoded into the program logic of these tools. Changing the development process (e.g., perhaps inserting an additional manager sign off at a particular stage) requires the tracking system program code to be changed. Setting up such a tracking system becomes a daunting and expensive task because each rule must be coded, compiled, and tested before it is deployed.

Several drawbacks exist. First, the tracking systems are inflexible to rapid changes in the development process because changing the process means altering, recompiling, and retesting the tracking system code. Second, because of the time and cost associated with setting up a tracking system, small development tasks, such as testing a specially designed patch for a particular customer, may not use the tracking system. Third, the time to delivery for software components may increase because of the time required to set up the development tracking system. It is thus desirable to create systems and methods for streamlining the software development process by creating a solution that is flexible and configurable.

### BRIEF DESCRIPTION OF THE DRAWINGS

FIG. 1 illustrates an example system for software development according to an embodiment of the present invention.

FIG. 2 illustrates example software development life cycles according to embodiments of the present invention.

FIG. 3a illustrates an example user interface according to an embodiment of the present invention.

FIG. 3b depicts an example user interface according to an embodiment of the present invention.

FIG. 4 depicts an example procedure for software development according to an embodiment of the present invention.

### DETAILED DESCRIPTION

Embodiments of the present invention involve a method, system, and apparatus to provide for a development object to be tracked and moved through a software development life cycle. For example, a development object may be a program code, a data dictionary entry, a repository entry, a data structure, etc. A development component may include the development object and a development status. The development status may correspond to a stage in the development object's software development life cycle at which the development object exists. For example, a development object may have been created and may be ready for testing. The development status may thus be “awaiting testing.” A status-action schema may be defined. The status-action schema may include a plurality of action rules that describe the flow of the development object through the software development life cycle. For example, action rules may include an action rule for sending a development object to the quality assurance manager when the development object's development status is “debugged.” The status-action schema may include an action rule that maps the status to an action. An action engine may perform the action on the development object by applying an appropriate action rule on the development object. An appropriate action rule may be selected by matching the development status with the status of an action rule. Applying the action rule may involve performing the action associated with the selected action rule. Example statuses may include status values of “inactive,” “active,” “active and transported,” and “active and deployed.” Active and transported may be a status to indicate that something is inhouse at the company/entity. Active and deployed may be a status to indicate that something has been shipped to an entity, e.g., a customer.

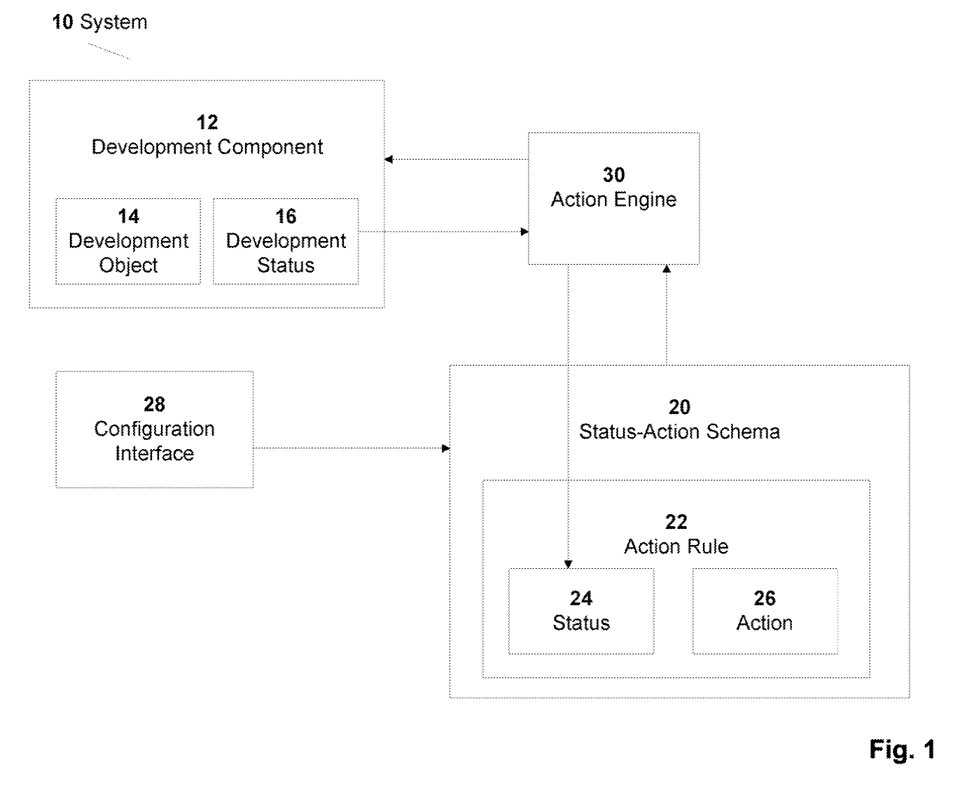

FIG. 1 depicts an example system for software development, according to an example embodiment of the present invention. A system 10 may include a development component 12. The development component 12 may include a development object 14 and a development status 16. The development object 14 may include any components of the software development life cycle that require tracking. For example, the software development object may include software code to be tested or a marketing document describing a software product. The development status 16 may include an indication of at what stage in the software development life cycle the development object 14 exists.

A status-action schema 20 may be defined to describe the flow of the development object through the software development life cycle. The status-action schema 20 may include an action rule 22. The action rule 22 may include a status 24 mapped to an action 26. The status 24 may include an indication of a particular stage of the software development life cycle. The action 26 may correspond to the action to be taken on the development object 14 at the stage indicated by the development status 16. For example statuses may include signed off by manager, development object coded, or development object tested with errors. Actions may include release the development object to the customer, send the development object for testing, or debug the development object, respectively.

A configuration interface 28 may provide an interface for the status-action schema 20 to be updated. An action engine 28 may perform the action indicated by the action 26 on the development object 14 by applying the action rule 22 on the development status 16.

In this way, the software development life cycle may be tracked in a streamlined manner. By creating an abstraction layer where statuses and actions may be configured and updated, the drawbacks associated with hard coded actions may be avoided. Changes may be made to the software development life cycle without modifying software code of the development life cycle tracking system. In addition, the development life cycle may continue to run while modifications to the life cycle itself are being made because the rules describing the life cycle may be separate from the components of the development process. Changes to the development process may be implemented in real time because the action rules may be applied as soon as they are modified. Finally, use of the configuration interface allows for centralized administration of the entire software development life cycle.

The development component 12 may store the relationship between the development status 16 and the development object 14. In one example embodiment, the development object 14 and development status 16 may be stored as separate elements within the development component 12. For example, the development component 12 may include a software object having references to the development status 16 and the development object 14. The fact that the development object 14 and development status 16 may be aggregated in the same development component 12 may indicate that the development status 16 is the status of the development object 14. Alternatively, the development status 16 and development object 14 may be stored as internal variables within the development component 12, instead of merely being stored as references. In another example embodiment the development status 16 may be stored as an element of the development object 14. For example, the development object 14 may include a reference pointer that points to the development status 16 or may include the development status 16 as a variable within the development object 14 itself. Alternatively, the development object 14 may be stored as an element of the development status 16 as appropriate. In practice, the implementation of the development component 12 and the implementation for indicating the relationship between the development status 16 and the development object 14, unless otherwise stated, is immaterial to the foregoing discussion.

The software development life cycle may describe various stages of software development. At each stage, a particular action may be taken with regard to a particular development object. The software development life cycle may be embodied in rules that define the actions to be taken at particular stages. It may be defined globally over various development objects, or it may be defined granularly for each development object. For example, a software development life cycle may be defined for a software development project in which all of the software components, documentation, data sets, and the like are to be sent to the quality assurance manager once they reach the status where the developer has signed off on them. In this example, a single action rule may describe this action for all of the included software components. In an alternative example embodiment, rules may be defined for each individual development object or defined on a subset. For example, one rule may define that all software components should be sent to the quality assurance manager once the developer has signed off on them. A second rule may instruct that documentation be sent to a proofreader before being sent to the quality assurance department. In another example, various quality assurance managers may be designated for various versions of a single software product. Various rules may designate that software components of already deployed software versions should be sent directly to the customer, when fully tested, in the form of software patches. Other rules may designate that software components for not yet released software versions should be sent to an integration manager to be included in the next release.

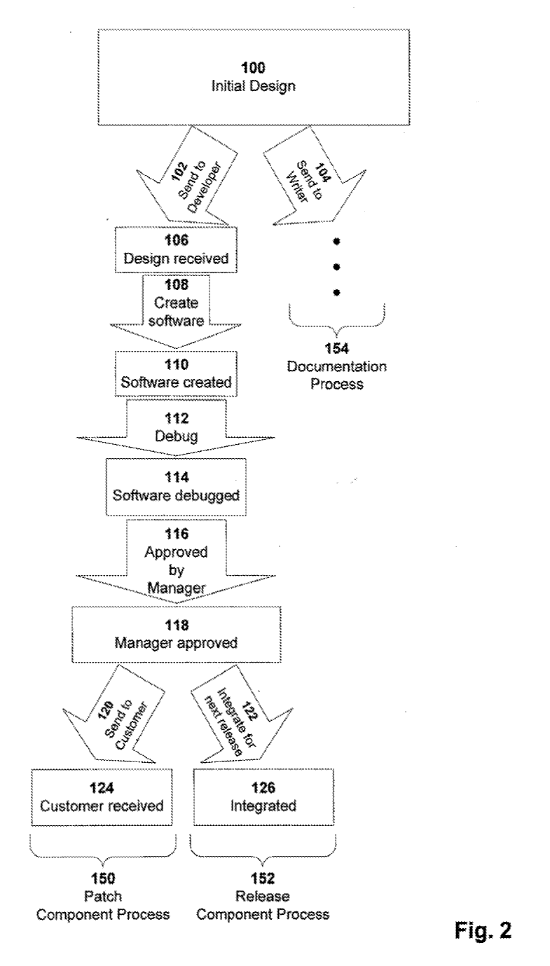

In an embodiment, the software development life cycles may exist in a tree structure. Each branch of the tree may correspond to the software development life cycle hr a single development object. The leaves of the tree may correspond to the finish states of the corresponding software development life cycles. Where the stages and actions for the software development life cycles for two development objects are the same, the branches may overlap. At the point that the stages and actions differ, the branches may split. An example tree structure according to an example embodiment of the present invention may be found in FIG. 2. FIG. 2 may include three software development life cycles-patch component process 150, release component process 152, and documentation process 154. The end products of the patch component process 150 and release component process 152 life cycles may be the same software components, but the patch component and release components may be related to two different software products. For example, the software development life cycles for release component process 152 and patch component process 150 may be designed to correct bugs in a particular software component. The end product of release component process 152 may be included in a future release of the software product, while the end product from patch component process 150 may be sent for immediate release to support a version of the product already released. Because patch component process 150 and release component process 152 may fix the same bugs, various stages and actions of these software development life cycles may overlap. This may be shown by patch component process 150 and release component process 152 including overlapping branches for portions of the life cycle.

The initial design stage 100 may include two actions-send to developer 102 and send to writer 104. The writer may be responsible for creating the document related to the patch component process 150 and release component process 152. The patch component process 150 and release component process 152 may include the same action-send to developer 102. Patch component process 150 and release component process 152 may also include the same stage design received 106, action create software 108, status software created 110, action debug 112, status software debugged 114, action approve by manager 116, and status manager approved 118. At this point, patch component process 150 may include an action send to customer 120, while release component process 152 may include an action integrate for next release 122. The patch component process 150 may terminate in a status of customer received 124. The release component process 152 may end in the state integrated 126.

With respect to FIG. 1, the development status 16 may indicate at what stage of the software development life cycle the development object 14 sits. The development status 16 may be stored in any appropriate form, including as a text identifier, as a software object, or as an integer. For example, the status-action schema may define various text strings to correspond to the various stages of the software development life cycle. These text strings may be defined in an arbitrary manner by the user, using the configuration interface 28. The fact that the user may define the stages of the software development life cycle in an arbitrary manner allows the system to be flexible. In one example embodiment, the system may consult the status-action schema for the proper text identifier to store in the development status 16 when assigning the development status 16 to the development object 14.

In another example embodiment, the development status 16 may include a software object with methods to query and set the status therein. For example, the development status 16 may include one method to set the status for each stage of the software development life cycle, such as setDeveloperSignedOff( ), setReadyForCustomerDeployment( ), setDesignApproved( ) and the like. In another example, the object may include one set method in which the identifiers DeveloperSigneOff, ReadyForCustomerDeployment, DesignApproved, and the like may be passed to the set method as parameters. The development status 16 may also include query methods to return the status of the development status 16. Still further, the development status 16 may include equality methods which compare two status objects to see if the statuses stored therein are the same.

The status-action schema may define various rules that instruct the system or the user to take particular actions on the development object 14 at various stages of the software development life cycle. The action rule 22 may include an action 26 that defines the action to be taken. Actions may include any real-world actions that may be taken on development objects. Actions may be defined in an arbitrary manner. This allows the system to be flexible. Any real-world action may be captured by the action 26. For example, actions may include “release to customer,” “print out,” “send to quality assurance manager,” “archive,” “send back for review,” “begin development,” “debug,” and the like. In one example embodiment, the action 26 may include more than one real-world action. For example, at the stage where the development object has been approved for release, the action may instruct the system to press CDs for delivery to customer, send the development object to be archived, and notify the marketing department of delivery to the customer. Like the development status 16, the action 26 may be stored in any appropriate form, such as a textual identifier, software object, or integer value. The development status 16 and the action 26 need not be stored in the same format. For example, the development status 16 may be stored as a software object whereas the action may be stored as an integer value.

Like the development status 16 and action 26, the status 24 may be stored in any appropriate format. Also like the action 26, the status 24 need not be stored in the same format as either the development status 16 or the action 26. As earlier described, the development status 16 and the status 24 may be matched to determine what action to take on the development object 14. The various statuses related to a single software development life cycle may be unique for a given software development life cycle for a particular development object. In this way, it may be clear exactly what action to take given a particular status.

The matching algorithm for matching the development status 16 with the status 24 may depend on how the development status 16 and status 24 are stored. Where native data types are used, native software functions may be employed. For example, the strcmp( ) function may judge equality on statuses stored as text strings. In another example embodiment, the ‘=’ operator may judge equality for statuses stored as integer values. In yet another example embodiment, the equalTo( ) method of a status stored as an object may take another status object as a parameter and determine whether the parameter status object includes the same status as the status object itself.

The statuses may also be stored in different formats. In this case, functions may exist for determining whether the statuses match. For example, a matching function may compare a status stored as a text string with a status stored as an object. A data structure may exist that includes mappings between equal statuses. For example, an array data structure may store the textual identifiers for various statuses at array positions corresponding to the integer value of the statuses. A status of 1 may correspond to a “code designed” status, and a status of 2 may correspond to a “code approved” status. The array may thus include array[1]=“code designed” and array[2]=“code approved.” To see if an integer status matches a textual status, a matching function may reference the textual identifier at the position indicated by the integer status and perform an strcmp( ) function to see if that textual identifier matches the status. For example, to see if a status of 2 corresponds to “code approved,” the code segment may include.

if (strcmp(array[2], “code approved”) == 0)
return True
else return false.

In example embodiments, the action rule 22 may be stored in an object-oriented manner, as a textual representation, or as database references. As objects, the status object may include an internal reference to the associated action. An action may be taken on the development object 14 by matching the development status 16 with the status, referencing the action object from the status object and calling a method within the referenced action object to perform the action. Where the rules are stored textually, an action rule interpreter may be called to perform the action (described below).

In an example embodiment, the status-action schema 20 may be constructed according to a status-action grammar. The status-action grammar may include grammar rules and grammar elements. Grammar elements may form the basic building blocks of valid action rules. For example, since action rules may include statuses and actions, grammar elements may include valid statuses. In another example embodiment, the status-action schema may be constructed according to the English language. In this case, grammar elements may include English words. In another example embodiment, grammar elements may be constructed from other grammar elements. For example, a sentence in the English language may be constructed of individual words. Both words and sentences may be considered grammar elements. Grammar rules may determine that grammar elements must be assembled in particular ways to form valid action rules.

In an example embodiment, the status-action schema may include a set of valid grammar elements that serve as the vocabulary for the action rules. For example, the set of grammar elements may include positions within the organization related to the software development life cycle. Positions may include “Developer,” “Quality Assurance Manager,” “Release Manager,” “Writer,” “Integration Manager,” and the like. Grammar elements may also include identifiers for individual development objects. For example, these identifiers may include designations for modules of code being developed. The modules may be identified by software product, version, and module title. An example of this triple may be “Email Program, V2.0, Virus Scanning Module.” Grammar elements may also include action commands, such as “transfer,” “approve,” “release,” and the like.

Grammar elements may be grouped into grammar types. A grammar type may reduce the number of grammar rules that need to be written by allowing a placeholder to serve as an element of the rule. For example, instead of including rules “transfer to Developer,” “transfer to Quality Assurance Manager,” and “transfer to Release Manager,” a single rule, “transfer to [Position]” may be written. [Position] may include a grammar type. Any grammar element falling into the grammar type [Position] may be inserted where [Position] is found in a rule.

The vocabulary for statuses may include different grammar elements than elements for actions. In an example embodiment, a status type may group together all grammar elements related to the status portion of the action rule and an action type may group together the grammar elements for the action portion. In this way, the possibility for improperly formed action rules may be reduced.

In another embodiment, grammar types may include grammar subtypes. For example, a grammar type for a bilingual status-action grammar, such as may be used for a multinational software development team, may include a grammar type for English and a grammar type for Russian. Subtypes may include nouns, verbs, and adjectives for each language.

Grammar rules may act on grammar types as well as grammar elements. For example, a rule may construct an action rule by grouping several grammar types together or may group grammar types with grammar elements. In the above example involving the English language grammar, a sentence may be constructed from a subject type, a verb type, and an object type. The subject type may itself be broken down into an adjective type and a noun type. Grammar elements may include individual words falling into the grammar types. For example, the noun type may include the words “developer,” “code,” and “manager,” A verb type may include “approve,” “transfer” and “release.”

Grammar rules may assemble grammar types and elements into grammar sentences. A grammar sentence of the status-action grammar may include action rules.

An example status-action grammar may include a status type, an action command type, and an action target type. Status types may include the grammar elements “in development,” “developed,” “debugging,” “debugged,” “awaiting testing,” “tested,” “released to customer,” and “integrated.” Action command types may include “develop,” “test,” “approve,” “transmit,” “release,” and “integrate.” Action target types may include “Developer,” “Quality Assurance Manager,” “Tester,” “Customer,” “Release Manager,” and “Archive.” In one example embodiment, a single rule for the status-action grammar may include a rule “[status type]->[action command type] [action target type].” In another example embodiment, a grammar rule may map a status to one or more actions. The grammar rule may nest other grammar rules. For example, a first rule may include “[status type]->(Action), (Action), . . . ” A second action rule, called Action, may include “[Action Command Type], [Action Target Type].” Thus, an example rule may include “tested”->“Approve,” “release, Customer,” “transmit, Archive.”

An action rule interpreter may interpret the action rules and perform the desired action. The action rule interpreter may parse the action rule and map the action into software. For example, given the action “transmit, Archive,” the interpreter may map “transmit” to a function that gathers the development object into a form that may be transmitted over a network. For example, the serialize( ) method may be called on the development object for this purpose. The “Archive” portion may be mapped to a network address, such as archive-incoming@company.com. The interpreter may perform the “transmit, Archive” function by sending the network-worthy development object to the address archive-incoming@company.com. The recipient of the development object may then archive the development object.

The status-action schema may be modified apart from the development objects themselves because the workflow of the software development life cycle may be abstracted from the development objects themselves. This may permit changes to the workflow to be made without halting the software development life cycle or retooling the software development system itself. In the same manner, in an example embodiment, changes to the status-action schema may be rolled out to the software development life cycle immediately.

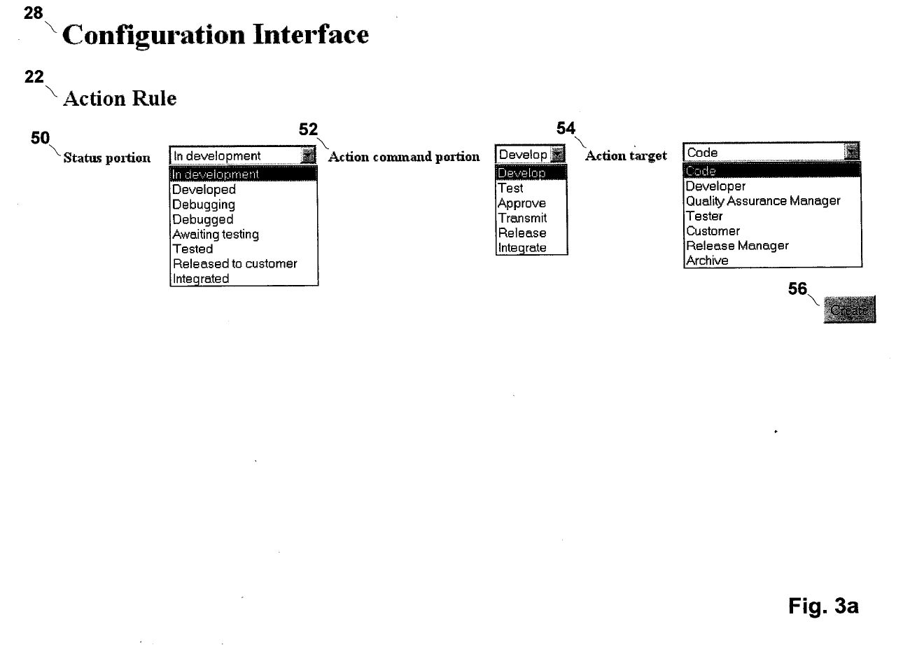

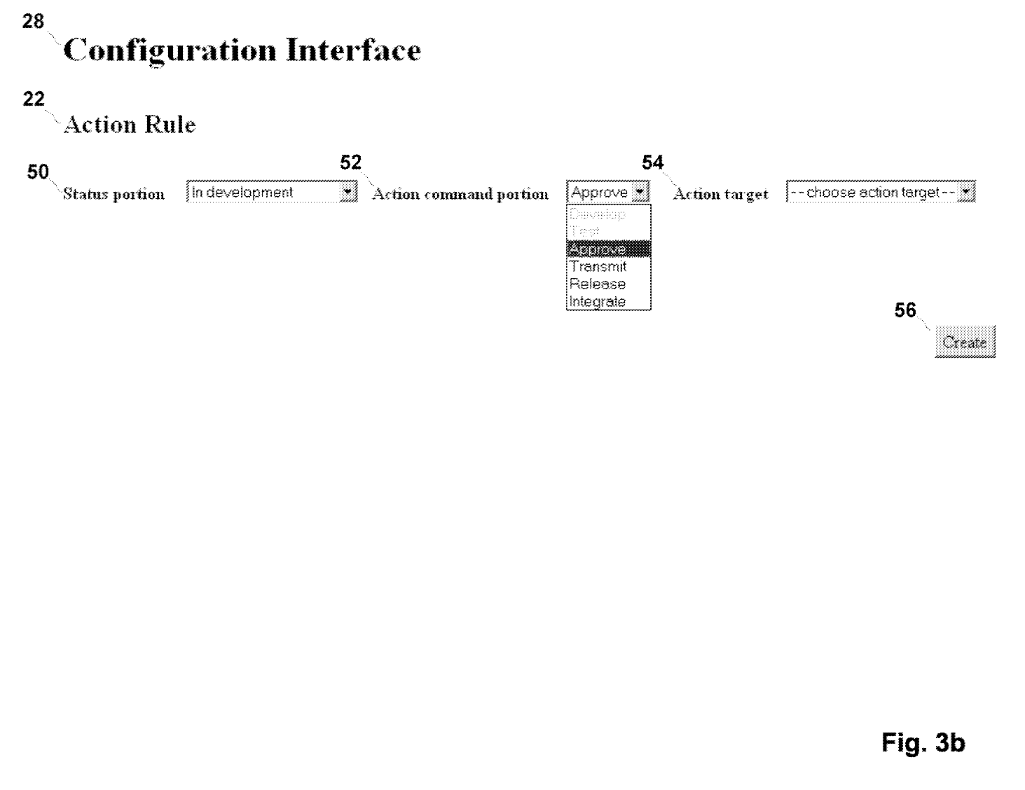

The configuration interface 28 may allow the status-action schema to be created and modified. The configuration interface 28 may present a user interface to a user or allow for electronic input of additions and modifications. FIG. 3a depicts an example user interface, according to an example embodiment of the present invention. The action rule 22 may include a status portion 50, an action command portion 52, and an action target portion 54. Each portion may permit the user to select from a valid set of identifiers for that portion. The status portion 50 may include the identifiers “in development,” “developed,” “debugging,” “debugged,” “awaiting testing,” “tested,” “released to customer,” and “integrated.” The action command portion 52 may include “develop,” “test,” “approve,” “transmit,” “release,” and “integrate.” The action target portion 54 may include “code,” “Developer,” “Quality Assurance Manager,” “Tester,” “Customer,” “Release Manager,” and “Archive.” The user may construct the action rule 22 by selecting identifiers from each portion and selecting the create button 56.

In an alternative embodiment, shown in FIG. 3b, once a selection is made in one portion, the identifiers unrelated to that selection in the remaining portions may be made unavailable. In this way, only valid action rules may be constructed. For example, by selecting “tested” in the status portion 50, the identifiers “develop” and “test” may be irrelevant and may be grayed out.

The action engine 30 may perform an action on the development object 14. The action engine 30 may match the development status 16 with the status of an action rule of the status-action schema. For example, the development status 16 may include the status “awaiting testing,” The action rule 22 may include the rule “awaiting testing” (status 24)->“test code” (action 26). The action engine 30 may match the development status 16 with the status 24 of the action rule 22. The action engine 30 may include an action rule interpreter that may perform the action “test, code.”

In an example embodiment, the action engine 30 may exist as a software program that runs apart from the software development life cycle. For example, the action engine 30 may run on a standalone server. The server may include a database for storing the status-action schema 20. The action engine 30 may receive development objects and their associated development statuses. Once received, the action engine may perform the corresponding action on the development object. As such, each time that the development status of a development object is changed, the development object may be sent to the action engine for processing to move the development object to the next stage.

In an alternative embodiment, the software development life cycle may relate to other development life cycles and workflows. For example, the development life cycle may be applied in a manufacturing context in which individual widgets or groups of widgets may be tracked and moved along the manufacturing process. In another example, the development life cycle may be applied in a sales fulfillment system. Each individual product may be tracked and moved through various steps from being received at the warehouse, catalogued, sold, packed, and shipped. Principles of the forgoing may be applied in any context in which objects may be moved through workflows. Each development object in these alternative embodiments may be an electronic representation of a real-world object, such as a manufacturing widget, or an actual electronic object, such as a purchase order, word processing document, or customer order.

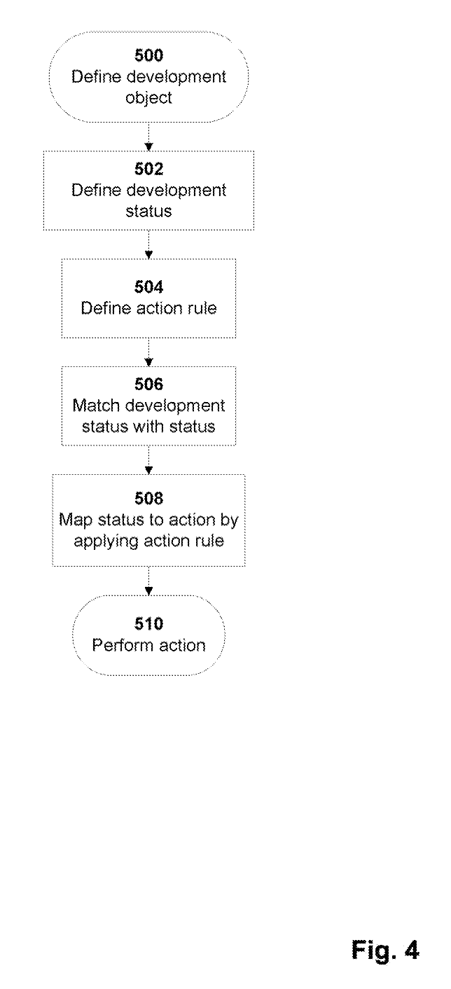

FIG. 4 shows a procedure for software development, according to an embodiment of the present invention. A development object may be defined (block 500). The development object may include any entity of a software development life cycle to be tracked or manipulated. For example, the development object may include a software component of a software product to be debugged. A development status may be defined for the development object (block 502). The development status may indicate at what stage of the software development life cycle the development object exists. For example, statuses for development of a software component may include “in development,” “developed,” “testing,” “tested,” “released,” and the like. An action rule may be defined (block 504). The action rule may map a status to an action. The development status of the development object may be matched with the status of the action rule (block 506). The status may then be mapped to the action by applying the action rule (block 508), and the action may be performed on the development object (block 510).

Several embodiments of the present invention are specifically illustrated and described herein. However, it will be appreciated that modifications and variations of the present invention are covered by the above teachings and within the purview of the claims without departing from the spirit and intended scope of the invention.

What is claimed is:

1. A system for software development comprising:
at least one development component including at least one development object and an associated development status;
an action rule configured to map a status to at least one action;
a status-action schema configured to define a development life cycle for the at least one development object, the development life cycle including the action rule; and
an action engine configured to perform the at least one action on the at least one development object according to the development status by matching the development status with the status and applying the mapped action rule.

2. The system of claim 1, wherein the at least one development object includes software code.

3. The system of claim 1, further comprising a configuration interface configured to update the status-action schema.

4. The system of claim 3, wherein the configuration interface is one of a web interface, and a user interface.

5. The system of claim 1, further comprising a status-action grammar including grammar rules for constructing action rules.

6. The system of claim 1, wherein the development life cycle includes a plurality of action rules.

7. The system of claim 1, wherein the status-action schema is updated at run time.

8. The system of claim 1, wherein the development life cycle is a software development life cycle.

9. The system of claim 1, wherein the development life cycle is a manufacturing life cycle.

10. The system of claim 1, wherein the development life cycle is a sales fulfillment life cycle.

11. A method for developing software comprising:
providing at least one development object including an associated development status;
providing an action rule configured to map a status to an action;
creating a status-action schema including a development life cycle for the at least one development object, the development life cycle including the action rule;
matching the development status to the status;
mapping the status to the action by applying the action rule; and
performing the action on the at least one development object.

12. The method of claim 11, further comprising defining at least one development object to include software code.

13. The method of claim 11, further comprising providing a configuration interface and updating the status-action schema using the configuration interface.

14. The method of claim 11, further comprising defining the status-action schema according to a status-action grammar, the status-action grammar including grammar rules for constructing action rules.

15. The method of claim 11, wherein the development life cycle includes a plurality of action rules.

16. The method of claim 11, further comprising updating the status-action schema at run time.

17. The method of claim 11, wherein the status-action schema includes a software development life cycle.

18. The method of claim 11, wherein the status-action schema includes a manufacturing life cycle.

19. The method of claim 11, wherein the status-action schema includes a sales fulfillment life cycle.

20. A system for software development comprising:
a first component configured to receive at least one development component, the at least one development component including an at least one development object and an at least one associated development status;
an action rule configured to map a status to an action;
a status-action schema configured to define a development life cycle for the at least one development object, the development life cycle including the action rule; and
an action engine configured to perform the action on the at least one development object according to the at least one associated development status by matching the at least one associated development status with the status and applying the action rule.
